(19) United States
(12) Patent Application Publication
(10) Pub. No.: US 2015/0022969 A1
(43) Pub. Date: Jan. 22, 2015

(54) COMPUTER CASE WITH RECORDED OPEN AND CLOSED STATES

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: XIAO-GANG YIN, Shenzhen (CN); JUN-HUI WANG, Shenzhen (CN)

(21) Appl. No.: 14/334,838

(22) Filed: Jul. 18, 2014

(30) Foreign Application Priority Data
Jul. 18, 2013 (CN) 2013103014247

(51) Int. Cl. G06F 21/86; G06F 1/18

(52) U.S. Cl. CPC G06F 21/86; G06F 1/181
USPC 361/679.57

(57) ABSTRACT

A computer case includes a backplane, a trigger switch, a first connector, a motherboard, a second connector on the motherboard, and a first cable. The trigger switch is used to detect whether a cover of the computer case is open or closed and outputs different signals accordingly. The first cable transmits the different signals from the trigger switch to the motherboard.

### FIELD

The subject matter herein generally relates to data security.

### BACKGROUND

A motherboard of a computer is located in and protected in a case of the computer.

### BRIEF DESCRIPTION OF THE DRAWINGS

Implementations of the present technology will now be described, by way of example only, with reference to the attached figures.

FIG. 1 is an isometric view of an embodiment of a computer casing.

FIG. 2 is a block diagram of an embodiment of a computer casing circuit.

FIG. 3 is a diagrammatic view of a first connector of the embodiment of the computer casing of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure describes a computer case.

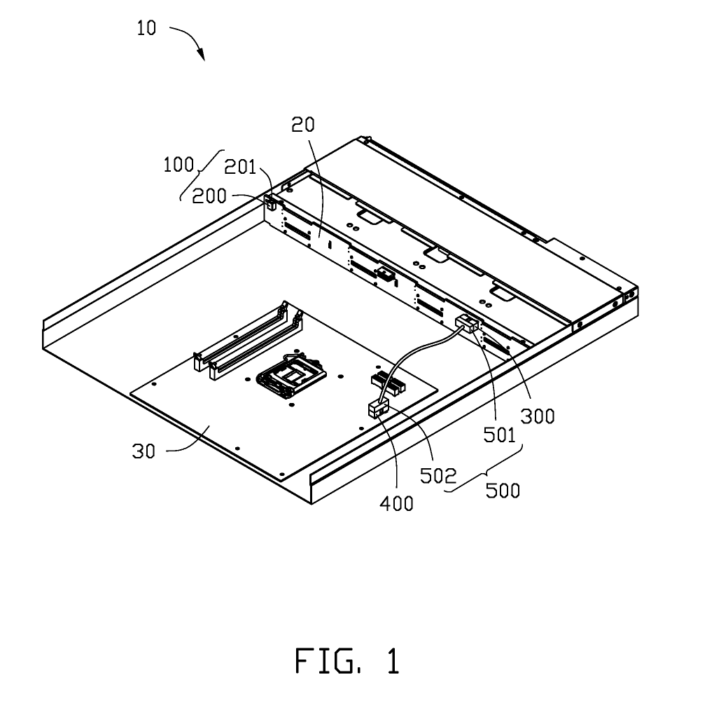

FIG. 1 illustrates a computer case 10, comprising a backplane 20, a trigger switch 100, a first connector 300, a motherboard 30, a second connector 400 on the motherboard 30, and a first cable 500.

The trigger switch 100 is located on the backplane 20 and is configured to detect whether a cover of the computer case 10 is open. The trigger switch 100 comprises a body section 200 and a button 201 movably attached to the body section 200. The body section 200 is located on the backplane 20. A first terminal of the button 201 is located in the body section 200.

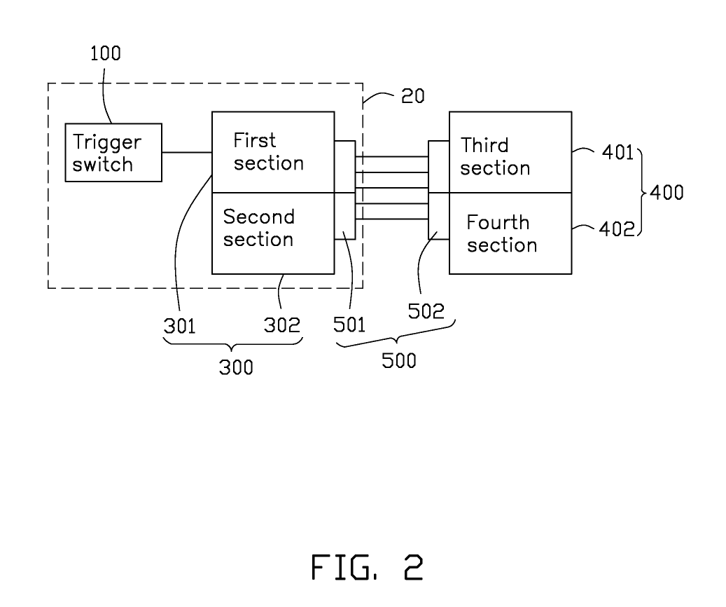

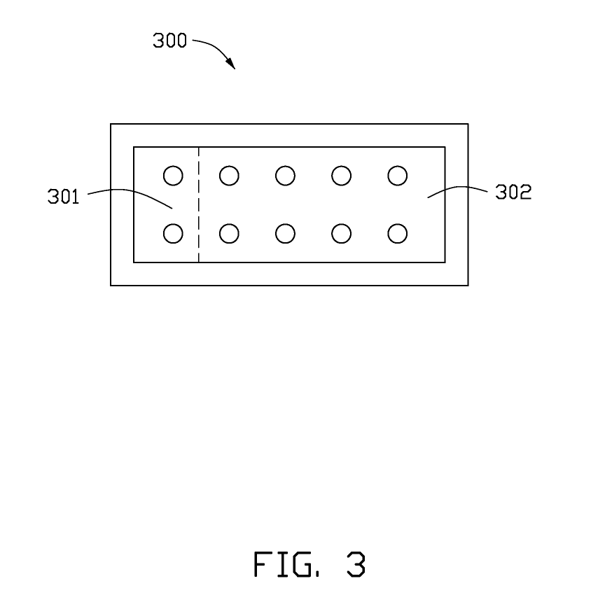

Referring to FIGS. 2 and 3, the first connector 300 comprises a first section 301 and a second section 302. The first connector 300 is coupled to the second connector 400 through the first cable 500. The second connector 400 comprises a third section 401 and a fourth section 402. The first cable 500 comprises a third connector 501 and a fourth connector 502. The trigger switch 100 is coupled to the first section 301 of the first connector 300 through trace connections. The first signal and the second signal are transmitted to the motherboard 30 through the first section 301. The second section 302 is used to transmit data between the backplane 20 and the motherboard 30.

In the embodiment, the first connector 300 and the second connector 400 are plugs. Pins of the first section 301 and pins of the second section 302 are arranged side by side.

The first cable 500 comprises a plurality of lines, the third connector 501, and the fourth connector 502. The third connector 501 and the fourth connector 502 are sockets.

When the cover of the computer case 10 is open, the button 201 is not depressed, and the trigger switch 100 outputs a first signal. The first signal is output to the motherboard 30 through the first connector 300, the first cable 500, and the second connector 400 in that order. The motherboard 30 receives the first signal and records a timestamp of receiving the first signal.

When the cover of the computer case 10 is closed on the computer case 10, the button 201 is depressed and the trigger switch 100 outputs a second signal. The second signal is output to the motherboard 30 through the first connector 300, the first cable 500, and the second connector 400 in that order. The motherboard 30 receives the second signal and records a timestamp of receiving the second signal. Accordingly, the users can be aware of the duration of time when the cover is closed.

The embodiments shown and described above are only examples. Many details are often found in the art such as the other features of a computer case. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A computer case comprising:
a backplane comprising a trigger switch and a first connector, wherein the trigger switch is configured to output a first signal when a cover of the computer case is open, output a second signal when the cover of the computer case is closed, the first connector comprises a first section and a second section, the first section is coupled to the trigger switch, and the second section is configured to transmit inherent signals to the backplane;
a motherboard comprising a second connector, the second connector comprising a third section and a fourth section; and
a cable comprising a third connector and a fourth connector, wherein the third connector configured to be coupled to the first connector, and the fourth connector configured to be coupled to the second connector.

2. The computer case of claim 1, wherein the trigger switch comprises a body section and a button, the body section is located on the backplane, the button is located on the body section and the button is movably attached to the body section, when the cover of the computer case is closed, the button is depressed and the trigger switch outputs the second signal, when the cover of the computer is open, the button is not depressed and the trigger switch outputs the first signal.

3. The computer case of claim 1, wherein the motherboard records a first timestamp when the motherboard receives the first signal, the motherboard records a second timestamp when the motherboard receives the second signal.
